(19) United States
(12) Patent Application Publication
(10) Pub. No.: US 2026/0131540 A1
(43) Pub. Date: May 14, 2026

(54) METHOD AND APPARATUS FOR PRODUCING AN INTERMITTENT GATHERED MATERIAL

(71) Applicant: HERRMANN ULTRASCHALLTECHNIK GMBH & CO. KG, Karlsbad (DE)

(72) Inventors: Vojislav RAKIC, Waldbronn (DE); Wilhelm HOFFMANN, Pforzheim (DE)

(21) Appl. No.: 19/386,700

(22) Filed: Nov. 12, 2025

(30) Foreign Application Priority Data
Nov. 14, 2024 (DE) 102024133311.1

(51) Int. Cl. B29C 65/08; B06B 1/10; B29C 65/80

(52) U.S. Cl. CPC B29C 65/085; B06B 1/10; B29C 65/80

(57) ABSTRACT

An apparatus and a method for intermittently processing a material. For this purpose, the apparatus has a tool with a sealing surface and a counter-tool with a counter-sealing surface, wherein the material is guided through a gap formed between the sealing surface and the counter-sealing surface in a feed direction during operation of the apparatus. In order to enable intermittent processing of the material, according to the invention the tool and/or the counter-tool is rotatable or pivotable about an axis such that a processing section of the sealing surface or of the counter-sealing surface can be arranged temporarily opposite the material, such that the material, when the processing section is arranged opposite the material, can be processed with the tool and, when the processing section is not arranged opposite the material, the material cannot be processed with the tool.

### FIELD OF THE INVENTION

The present invention relates to an apparatus and a method for intermittently processing a material. For this purpose, the apparatus has a tool with a sealing surface and a counter-tool with a counter-sealing surface, the material is guided through a gap formed between the sealing surface and the counter-sealing surface in a feed direction during operation of the apparatus.

### BACKGROUND OF THE INVENTION

In the manufacture of various products in which, for example, web-shaped materials are processed, a requirement of the manufacturing process is often not to process the material continuously, but only in certain regions. This so-called intermittent processing of a material is used, for example, in the production of diapers in order to create regions with high extensibility and regions with lower extensibility. At the same time, the intermittent processing ensures that there are sufficient unprocessed regions between the material layers of the diaper, since in this way the breathability of the diaper is ensured.

Various solutions are known from the prior art for this purpose. In the production of diapers, an adhesive is often used which is applied only in certain regions in order to join together locally the plurality of material layers of a diaper. This adhesive is used, for example, to fix elastic threads between two material layers, which are tensioned during fixation. When the threads are relaxed, the material produced is gathered due to the spot-wise fixation to the material layers. However, this solution requires precise application of the adhesive in order to ensure that the various components of the diaper are securely and firmly joined together. Furthermore, the nozzles for applying the adhesive can become clogged and thus delay the manufacturing process. In addition, the use of adhesives can cause skin irritation or an unpleasant wearing sensation.

An alternative solution therefore consists in the use of ultrasound to join the various components of a diaper. In order, when using ultrasound, to weld only individual regions of the starting materials to one another, a so-called pattern roll is often used as a counter-tool, which, due to a corresponding surface structure, results in processing of the material in certain regions and not in certain regions. Each pattern roll is therefore individually tailored to the product to be manufactured. If a product with a different intermittent structure is to be produced, the machine for manufacturing the material always has to be adapted accordingly. On the one hand, this requires appropriate know-how and, on the other hand, additional costs and set-up times are incurred.

A further solution could also consist in bringing the tool into contact with the material only at certain times by moving the tool up and down in a direction perpendicular to the feed direction. However, this requires additional control and mechanics in order to move the tool in accordance with the desired processing interval. High processing speeds cannot be achieved in this way, since adjustment of the tool in a direction perpendicular to the feed direction takes time and it must also be ensured that the gap between the tool and the counter-tool is correctly set again after each downward movement of the tool. If the gap is not set precisely enough, the material is either destroyed or processed insufficiently. Such adjustment of the tool is therefore also associated with correspondingly high costs due to the necessary precision.

### SUMMARY OF THE INVENTION

The object of the present invention is therefore to provide an apparatus and a method for intermittently processing a material, which permit intermittent processing of a material with simple means and can be easily adapted to changed product requirements.

The object underlying the invention is achieved by an apparatus of the type mentioned at the outset, wherein the tool and/or the counter-tool is rotatable or pivotable about an axis such that a processing section of the sealing surface or of the counter-sealing surface can be arranged temporarily opposite the material during operation of the apparatus, such that the material, when the processing section is arranged opposite the material, can be processed with the tool and, when the processing section is not arranged opposite the material, the material cannot be processed with the tool.

In other words, according to the invention it is provided that the processing section is not permanently in contact with the material, but the processing section comes into contact with the material only temporarily by a rotational or pivoting movement of the tool or of the counter-tool.

In one embodiment, the term “temporarily” means in particular that the processing section of the tool is brought into contact with the material for a certain period of time, i.e. no continuous pivoting or rotational movement of the tool takes place, but this is interrupted for a time during processing.

By the rotational or pivoting movement of the tool or of the counter-tool according to the invention and the associated temporary contact of the processing section, intermittent processing of the material can be carried out in a simple manner. The processing result primarily depends on the pivoting or rotational frequency of the tool or of the counter-tool and can be individually adapted to the desired product without having to replace components in the tool. The need for special pattern rolls is thus eliminated. A pivoting or rotational movement can also be carried out very precisely by simple technical means. The design according to the invention therefore saves costs and time in the intermittent processing of a material.

A pivoting movement within the meaning of the present invention is understood to be a rotational movement about an axis, wherein no complete rotation about the axis takes place, but rather a pendulum movement in a limited angular range about the axis. In other words, a pivoting movement is a limited rotary movement in which the tool oscillates back and forth between two end positions.

In one embodiment, the sealing surface and/or the counter-sealing surface is at least partially curved, the sealing surface or the counter-sealing surface in the curved region having a first section and the processing section, the first section and the processing section being arranged one behind the other in the feed direction, the tool or the counter-tool being pivotable or rotatable about a focal point of the curved region such that the first section and the processing section are arranged successively opposite the material during operation of the apparatus by the pivoting or rotational movement of the tool or of the counter-tool about an axis through the focal point, the first section and the processing section being configured in such a way that, when the first section is arranged opposite the material, the gap between the sealing surface and the counter-sealing surface is larger than when the processing section is arranged opposite the material, such that the material, when the processing section is arranged opposite the material, can be processed with the tool and, when the first section is arranged opposite the material, the material cannot be processed with the tool, the first section preferably being formed as a recess in the sealing surface or the counter-sealing surface.

In other words, it is thus provided that, for example, the tool performs a pivoting or rotational movement in order to arrange the first section or the processing section, which in this case are arranged on the sealing surface of the tool, opposite the counter-tool in such a way that the gap in which the material is guided is formed either between the first section and the counter-tool or between the processing section and the counter-tool. It is understood that, alternatively, in one embodiment the counter-tool can perform the pivoting or rotational movement, in which case the counter-sealing surface has the first section and the processing section.

The first section and the processing section are configured in such a way that the gap, when the first section is arranged opposite the counter-tool or the tool and thus also opposite the material, is larger than when the processing section is arranged opposite the counter-tool or the tool and thus also opposite the material. According to the invention, the gap difference is selected such that, when the first section is arranged opposite the material, there is no processing of the material, whereas when arranged opposite the processing section, the material is processed. For this purpose, the surface points of the first section of the sealing surface have a smaller distance from the focal point of the curved region than surface points of the processing section of the sealing surface.

In one embodiment, the apparatus is an ultrasonic processing apparatus, the tool being a sonotrode which is acted upon by an ultrasonic vibration during operation of the apparatus. When the sonotrode comes into contact with the material to be processed, the vibrational energy is introduced into the material, whereby the latter is heated and, for example, material layers are locally fused.

It is understood that the solution according to the invention is also suitable for other types of tools, such as thermal tools, in which a correspondingly heated sealing surface or counter-sealing surface is brought into contact with the material for processing. Even if the embodiments below are described mainly against the background of an ultrasonic tool, the teaching can easily be transferred to other types of tools, in particular thermal tools.

In a further embodiment, the material consists of at least two web sections of material and at least one thread arranged between the web sections of material, the processing section having at least one groove for at least partial accommodation of the at least one thread, the groove being oriented in the feed direction so that a gathered or gatherable material can be produced with the apparatus. For this purpose, the thread is tensioned during processing and clamped between two processing points of the material layers in such a way that the material is gathered when the thread is relaxed.

Preferably, the at least one groove has a smaller depth in the region of the first section than in the region of the processing section, particularly preferably no groove being formed in the first section.

The grooves in which the thread is at least partially accommodated cause projections to be formed on the sealing surface between the grooves. In the region of these projections, the material layers fuse when the projections come into contact with the material. If the grooves are removed or flattened in the region of the first section, the projections project less from a base surface of the sealing surface and there is correspondingly weaker or no processing of the material.

A corresponding tool can be manufactured particularly easily by removing the existing groove structure in at least one region in roll-shaped sonotrodes known from the prior art. In this way, a flexible apparatus can be provided with simple means for producing a gatherable material which permits intermittent processing.

In a further embodiment, the sealing surface or the counter-sealing surface has at most two, preferably exactly one, processing section.

In a further embodiment, only the processing section has a structure for processing the material. For example, certain patterns can be embossed into the material which affect the extensibility and wearing sensation of the finished product.

In a further embodiment, the curved region is a circular-arc section and the pivoting or rotational movement of the tool or of the counter-tool takes place about a center point of the circle of the circular-arc section.

In particular, pivoting or rotational movements of a tool or counter-tool with a circular circumferential surface can be generated very precisely with simple means. In one embodiment in particular, the processing section is brought into contact with the material temporarily by one full revolution of the tool or of the counter-tool.

In a further embodiment, the tool and/or the counter-tool has a rotationally symmetrical, preferably circular, circumferential surface on which the sealing surfaces or the counter-sealing surface are arranged. In particular, in one embodiment with rotationally symmetrical tools or counter-tools, it is also conceivable that further sections are present on the sealing surface or the counter-sealing surface, the gap size varying for each section. In this way, simply by rotating the tool it is also possible to respond to different material thicknesses without having to convert the apparatus.

In a further embodiment, the first section and the processing section extend completely over the sealing surface in a direction perpendicular to the feed direction.

In a further embodiment, the pivoting movement covers an angle of at most 45°, preferably of at most 20°. Thus, a very small pivoting movement is already sufficient to achieve the desired processing result. Production times can thereby be increased, since the pivoting movement can be performed at a very high frequency.

In a further embodiment, the first section and the processing section are arranged on the sealing surface of the tool. As a counter-tool, any, for example cylindrical, roller can then be used, on the surface of which no particular requirements are imposed.

The object underlying the invention is further achieved by a method for intermittently processing a material, the method comprising the following steps:
a) Providing a tool with a sealing surface and a counter-tool with a counter-sealing surface,
b) Guiding the material through a gap formed between the sealing surface and the counter-sealing surface in a feed direction,
c) Temporarily arranging a processing section of the sealing surface or of the counter-sealing surface opposite the material, such that the material, when the processing section is arranged opposite the material, is processed with the tool and, when the processing section is not arranged opposite the material, the material is not processed with the tool,
the temporary arranging in step c) taking place by a pivoting or rotational movement of the tool or of the counter-tool about an axis.

By the pivoting or rotational movements, the processing section is thus temporarily arranged opposite the material. If the processing section is arranged opposite the material, processing of the material occurs when the tool is, for example, excited with ultrasound; if the processing section is not arranged opposite the material, for example when the sealing surface or the counter-sealing surface is turned completely away from the material or when a section other than the processing section is arranged opposite the material, no processing of the material occurs. The ultrasonic excitation of the tool does not have to be interrupted, but can continue, since, due to the larger gap in the region of the other section, for example the first section, and/or due to turning away of the complete sealing surface, it is ensured that no processing of the material takes place. This makes it possible to achieve more stable process conditions when the tool can be operated continuously.

According to the method of the invention, the temporal sequence of the temporary arranging in step c) determines the processing result of the material. Depending on the frequency with which the contact with the processing section is changed, an intermittent processing pattern is produced on the material.

In one embodiment, during step c. the pivoting or rotational movement of the tool or of the counter-tool is interrupted for a certain time during which the material is processed. The tool or the counter-tool is therefore not moved continuously, but discontinuously.

### BRIEF DESCRIPTION OF THE DRAWINGS

Further advantages, features and possibilities for application of the present invention will become apparent from the following description of various embodiments of the invention.

FIG. 1 shows a schematic illustration of a first embodiment of the apparatus according to the invention.

FIG. 2a shows an enlargement of the first embodiment shown in FIG. 1, in which the second section is arranged opposite the material.

FIG. 2b shows an enlargement of the first embodiment shown in FIG. 1, in which the first section is arranged opposite the material.

FIG. 3 shows a schematic illustration of a second embodiment of the apparatus according to the invention.

### DETAILED DESCRIPTION OF THE INVENTION

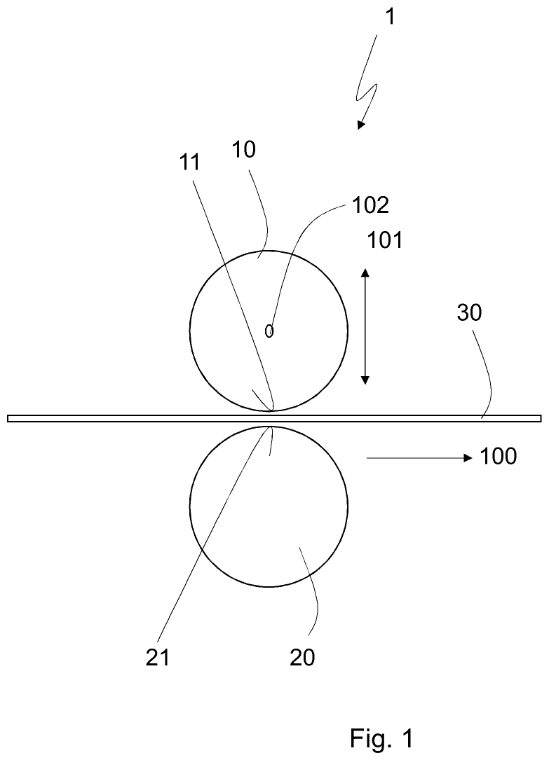

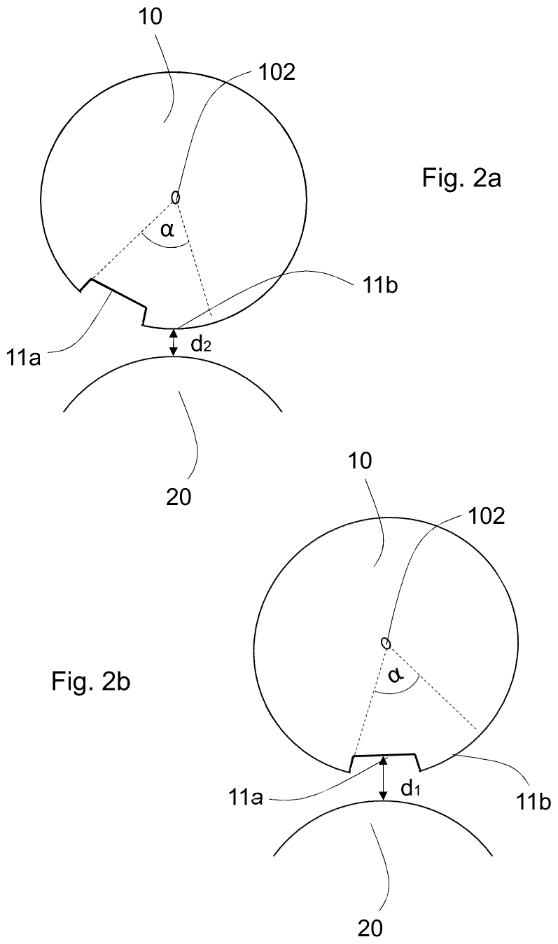

The first embodiment of the apparatus 1 according to the invention shown in FIGS. 1, 2a and 2b has a tool 10 and a counter-tool 20, the tool 10 having a sealing surface 11 and the counter-tool 20 having a sealing surface 21. The tool 10 and the counter-tool 20 are arranged relative to one another in such a way that a material 30 is guided in a feed direction 100 through a gap between the sealing surface 11 of the tool 10 and the counter-sealing surface 21 of the counter-tool 20.

In order to process the material 30 guided in the gap, the tool 10, which is, for example, a sonotrode of an ultrasonic tool, is subjected to an ultrasonic vibration in the direction of the axis 101. This results in a partial heating of the material 30, whereby several layers of the material fuse with one another.

In order to enable intermittent processing of the material 30, the tool 10 is mounted pivotably about a pivot axis through the focal point 102 and can perform a pivoting movement in the region of the angle α. In the circular-arc section of the angle α, a first section 11a of the sealing surface 11 and a processing section 11b of the sealing surface 11 are arranged one behind the other in the feed direction 100 and are arranged successively opposite the counter-sealing surface 21 of the counter-tool 20 and the material 30. It is understood that the temporary, successive arranging of the first section 11a and the processing section 11b opposite the material 30 and the counter-tool 20 can also be achieved by one full rotation of the tool 10.

The first section 11a and the processing section 11b are configured such that a distance d₂ between the processing section 11b and the counter-sealing surface 21 of the counter-tool 20 is smaller than a distance d₁ between the first section 11a and the counter-sealing surface 21 of the counter-tool 20. As a result, the material 30 is processed when the processing section 11b is arranged opposite the counter-sealing surface 21 of the counter-tool 20 (see FIG. 2a), whereas no processing of the material 30 takes place when the first section 11a is arranged opposite the counter-sealing surface 21 of the counter-tool 20 (see FIG. 2b).

It is understood that the sections 11a and 11b can likewise also be provided on the curved counter-sealing surface 21 of the counter-tool 20, in which case the counter-tool 20 is pivotable about an axis through a focal point of the curved counter-sealing surface. Furthermore, processing structures and/or grooves for thread guidance can be provided on the processing section, which, due to the schematic representation of the embodiments, are not shown in detail.

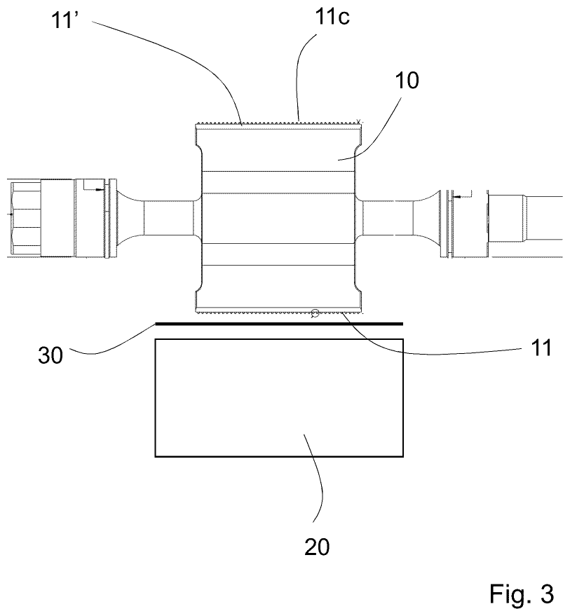

In the second embodiment shown in FIG. 3, the tool 10 is pivotable or rotatable about a longitudinal axis 103. In this way, sealing surfaces 11 and 11′ are brought into contact with the material 30 temporarily, so that intermittent processing takes place. In this embodiment, therefore, the sealing surface 11, 11′ does not have two sections with different gap sizes to the counter-tool 20, but the sealing surface 11, 11′ is rotated or pivoted in such a way that there is no longer any contact with the material 30. The sealing surface 11, 11′ can therefore be provided completely with processing structures or grooves 11c for thread guidance.

What the two embodiments have in common is that the material 30 can be processed intermittently by a simple pivoting or rotational movement of the tool 10.

Reference signs

| | |
|---|---|
| 1 | Apparatus |
| 10 | Tool |
| 11, 11′ | Sealing surface |
| 11a | First section |
| 11b | Processing section |
| 11c | Grooves |
| 20 | Counter-tool |
| 21 | Counter-sealing surface |
| 30 | Material |
| 100 | Feed direction |
| 101 | Direction of vibration |
| 102 | Focal point |
| 103 | Longitudinal axis |

What is claimed is:

1. An apparatus for intermittently processing a material, comprising:
a tool with a sealing surface and a counter-tool with a counter-sealing surface, wherein the material is guided through a gap formed between the sealing surface and the counter-sealing surface in a feed direction during operation of the apparatus,
wherein the tool and/or the counter-tool is rotatable or pivotable about an axis such that a processing section of the sealing surface or of the counter-sealing surface can be arranged temporarily opposite the material during operation of the apparatus, such that the material, when the processing section is arranged opposite the material, can be processed with the tool and, when the processing section is not arranged opposite the material, the material cannot be processed with the tool.

2. The apparatus according to claim 1, wherein the sealing surface and/or the counter-sealing surface are at least partially curved, the sealing surface or the counter-sealing surface in the curved region having a first section and the processing section, the first section and the processing section being arranged one behind the other in the feed direction, the tool or the counter-tool being pivotable or rotatable about a focal point of the curved region such that the first section and the processing section are arranged successively opposite the material during operation of the apparatus by the pivoting or rotational movement of the tool or of the counter-tool about an axis through the focal point, the first section and the processing section being configured in such a way that, when the first section is arranged opposite the material, the gap between the sealing surface and the counter-sealing surface is larger than when the processing section is arranged opposite the material, such that the material, when the processing section is arranged opposite the material, can be processed with the tool and, when the first section is arranged opposite the material, the material cannot be processed with the tool, the first section preferably being formed as a recess in the sealing surface or the counter-sealing surface.

3. An apparatus according to claim 2, wherein the apparatus is an ultrasonic processing apparatus, the tool being a sonotrode which is acted upon by an ultrasonic vibration during operation of the apparatus.

4. The apparatus according to claim 1, wherein the material consists of at least two web sections of material and at least one thread arranged between the web sections of material, the processing section having at least one groove for at least partial accommodation of the at least one thread, the groove being oriented in the feed direction, so that a gathered or gatherable material can be produced with the apparatus, preferably the at least one groove having a smaller depth in the region of the first section than in the region of the processing section, particularly preferably no groove being formed in the first section.

5. The apparatus according to claim 1, wherein the sealing surface or the counter-sealing surface has at most two, preferably exactly one, processing section.

6. The apparatus according to claim 1, wherein only the processing section has a structure for processing the material.

7. The apparatus according to claim 1, wherein the curved region is a circular-arc section and the pivoting or rotational movement of the tool or of the counter-tool takes place about a center point of the circle of the circular-arc section.

8. The apparatus according to claim 1, wherein the tool and/or the counter-tool has a rotationally symmetrical, preferably circular, circumferential surface on which the sealing surface or the counter-sealing surface are arranged.

9. The apparatus according to claim 1, wherein the first section and the processing section extend completely over the sealing surface in a direction perpendicular to the feed direction.

10. The apparatus according to claim 1, wherein the pivoting movement covers an angle α of at most 45°, preferably of at most 20°.

11. An apparatus according to claim 1, wherein the first section and the processing section are arranged on the sealing surface of the tool.

12. A method for intermittently processing a material, comprising the steps:
a. providing a tool with a sealing surface and a counter-tool with a counter-sealing surface,
b. guiding the material through a gap formed between the sealing surface and the counter-sealing surface in a feed direction, and
c. temporarily arranging a processing section of the sealing surface or of the counter-sealing surface opposite the material, such that the material, when the processing section is arranged opposite the material, is processed with the tool and, when the processing section is not arranged opposite the material, the material is not processed with the tool,
the temporary arranging in step c. taking place by a pivoting or rotational movement of the tool or of the counter-tool about an axis.

13. The method according to claim 12, wherein during step c. the pivoting or rotational movement of the tool or of the counter-tool is interrupted for a certain time during which the material is processed.

14. The apparatus according to claim 3, wherein the material consists of at least two web sections of material and at least one thread arranged between the web sections of material, the processing section having at least one groove for at least partial accommodation of the at least one thread, the groove being oriented in the feed direction, so that a gathered or gatherable material can be produced with the apparatus, preferably the at least one groove having a smaller depth in the region of the first section than in the region of the processing section, particularly preferably no groove being formed in the first section, and wherein the sealing surface or the counter-sealing surface has at most two, preferably exactly one, processing section.

15. The apparatus according to claim 14, wherein only the processing section has a structure for processing the material, and wherein the curved region is a circular-arc section and the pivoting or rotational movement of the tool or of the counter-tool takes place about a center point of the circle of the circular-arc section.

16. The apparatus according to claim 15, wherein the tool and/or the counter-tool has a rotationally symmetrical, preferably circular, circumferential surface on which the sealing surface or the counter-sealing surface are arranged, and wherein the first section and the processing section extend completely over the sealing surface in a direction perpendicular to the feed direction.

17. The apparatus according to claim 16, wherein the pivoting movement covers an angle α of at most 45°, preferably of at most 20°, and wherein the first section and the processing section are arranged on the sealing surface of the tool.
